(19) United States
(12) Patent Application Publication
(10) Pub. No.: US 2026/0356314 A1
(43) Pub. Date: Nov. 12, 2026

(54) CONTROL APPARATUS

(71) Applicant: SUBARU CORPORATION, Tokyo (JP)

(72) Inventor: Kousei KAWAMURA, Tokyo (JP)

(21) Appl. No.: 19/662,330

(22) Filed: Apr. 29, 2026

(30) Foreign Application Priority Data
May 12, 2025 (JP) 2025-079759

(51) Int. Cl. B60R 21/013; B60R 21/34; B60R 21/01

(52) U.S. Cl. CPC B60R 21/013; B60R 21/34; B60R 2021/01286

(57) ABSTRACT

A control apparatus is configured to control an occupant protection device and a pedestrian protection device that are configured to be mounted in a vehicle. The control apparatus includes one or more processors and one or more memories communicably coupled to the oner or more processors. The one or more processors are configured to modify a threshold of a second sensor, based on a detection value of a first sensor. The first sensor is disposed on a front body of the vehicle and usable in determining whether to actuate the pedestrian protection device. The second sensor is disposed on the front body of the vehicle and usable in determining whether to actuate the occupant protection device.

### CROSS-REFERENCE TO RELATED APPLICATIONS

The present application claims priority from Japanese Patent Application No. 2025-079759 filed on May 12, 2025, the entire contents of which are hereby incorporated by reference.

### BACKGROUND

The disclosure relates to a control apparatus.

Existing control is known which develops an air-bag when a frontal contact of a vehicle is detected.

Japanese Unexamined Patent Application Publication (JP-A) No. 2002-096707, for example, discloses a contact form determination device that includes a first sensor, a second sensor, and a contact form determiner. The first sensor and the second sensor are disposed at respective positions in a crash zone of a frontal body of a vehicle, and configured to output signals in accordance with a load applied in a vehicle-width direction. The contact form determiner is configured to determine a form of contact of the vehicle, based on a relation between the output signal of the first sensor and the output signal of the second sensor. JP-A No. 2002-096707 further describes that satellite sensors corresponding to the first sensor and the second sensor are each an electronic biaxial sensor configured to output a signal in accordance with a magnitude of acceleration applied to the position of the sensor in the vehicle-with direction and output a signal in accordance with a magnitude of deceleration applied in a longitudinal direction of the vehicle.

### SUMMARY

An aspect of the disclosure provides a control apparatus configured to control an occupant protection device and a pedestrian protection device that are configured to be mounted in a vehicle. The control apparatus includes one or more processors and one or more memories communicably coupled to the oner or more processors. The one or more processors are configured to modify a threshold of a second sensor, based on a detection value of a first sensor. The first sensor is disposed on a front body of the vehicle and usable in determining whether to actuate the pedestrian protection device. The second sensor is disposed on the front body of the vehicle and usable in determining whether to actuate the occupant protection device.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a schematic diagram illustrating a structure of a front body of a vehicle including a control apparatus according to one example embodiment of the disclosure.

FIG. 2 is a schematic view of the vehicle including the control apparatus illustrated in FIG. 1 in which an occupant protection device and a pedestrian protection device are actuated.

FIG. 3 is a block diagram illustrating an exemplary configuration of the control apparatus illustrated in FIG. 1.

FIG. 4 is an explanatory diagram illustrating thresholds of first to third sensors to be used in control at the control apparatus illustrated in FIG. 1.

FIG. 5 is a flowchart describing an exemplary operation of the control apparatus illustrated in FIG. 1.

FIG. 6 is a flowchart describing details of pedestrian protection control described in FIG. 5.

FIG. 7 is a flowchart describing details of occupant protection control described in FIG. 5.

In the existing technique disclosed in JP-A No. 2002-096707, an input to an acceleration sensor to actuate an occupant protection device can be insufficient when a center-pole contact of the front body of the vehicle with an object such as an utility pole or an underride contact in which the front body of the vehicle drives under a rear portion of a contact body such as a truck has occurred. Accordingly, there is room for improvement in earlier actuation of the occupant protection device.

It is desirable to provide a control apparatus enabling earlier actuation of an occupant protection device upon a center pole contact or an underride contact.

### DETAILED DESCRIPTION

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Vehicle

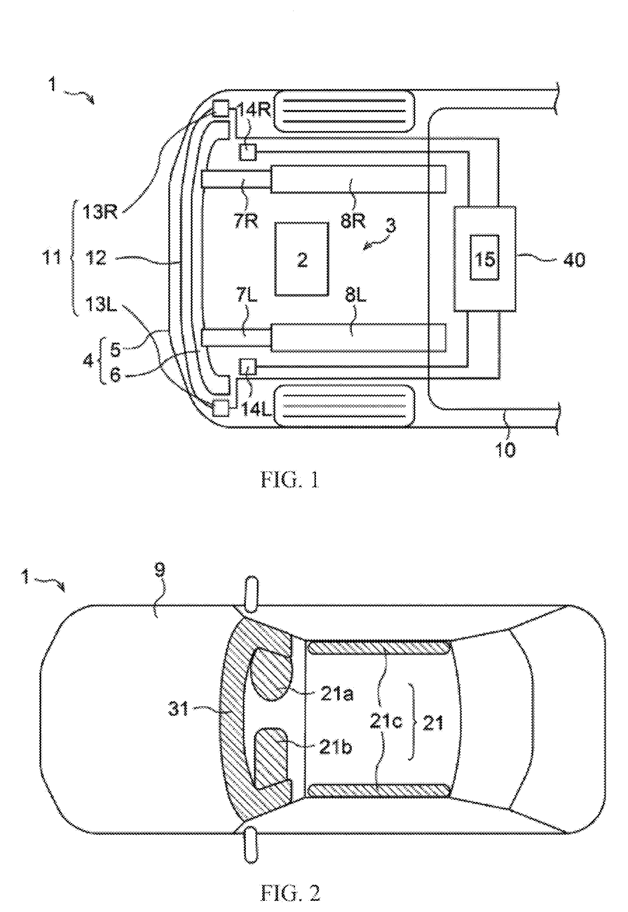

As illustrated in FIG. 1, a front body of a vehicle 1 may include a frontal housing space 3 in which a driving power source 2 is accommodated. The driving power source 2 may be, for example, an internal combustion engine such as a gasoline engine or diesel engine; however, this is non-limiting. In some embodiments, the driving power source 2 may be a drive motor to be applied to an electric vehicle. Non-limiting examples of the electric vehicle may include a battery electric vehicle (BEV), a hybrid electric vehicle (HEV), a plug-in hybrid electric vehicle (PHEV), and a fuel cell electric vehicle (FCEV).

A front bumper 4 may be provided on a front end of the frontal housing space 3. The front bumper 4 may include a bumper beam 5 and a bumper face 6. The bumper beam 5 may be attached to a front end of a left-front side frame 8L with a left bumper beam stay 7L interposed therebetween. Further, the bumper beam 5 may be attached to a front end of a right-front side frame 8R with a right bumper beam stay 7R interposed therebetween. A left-front wheel may be disposed at an outside position relative to a middle portion of the left-front side frame 8L in a vehicle-width direction. A right-front wheel may be disposed at an outside position relative to a middle portion of the right-front side frame 8R in the vehicle-width direction. The bumper face 6 may be an exterior member including, for example, a resin-based material, and may be attached to a frontal portion of the bumper beam 5. Upon a frontal contact of the vehicle 1, the bumper beam 5 may receive a load from a contact body via the bumper face 6.

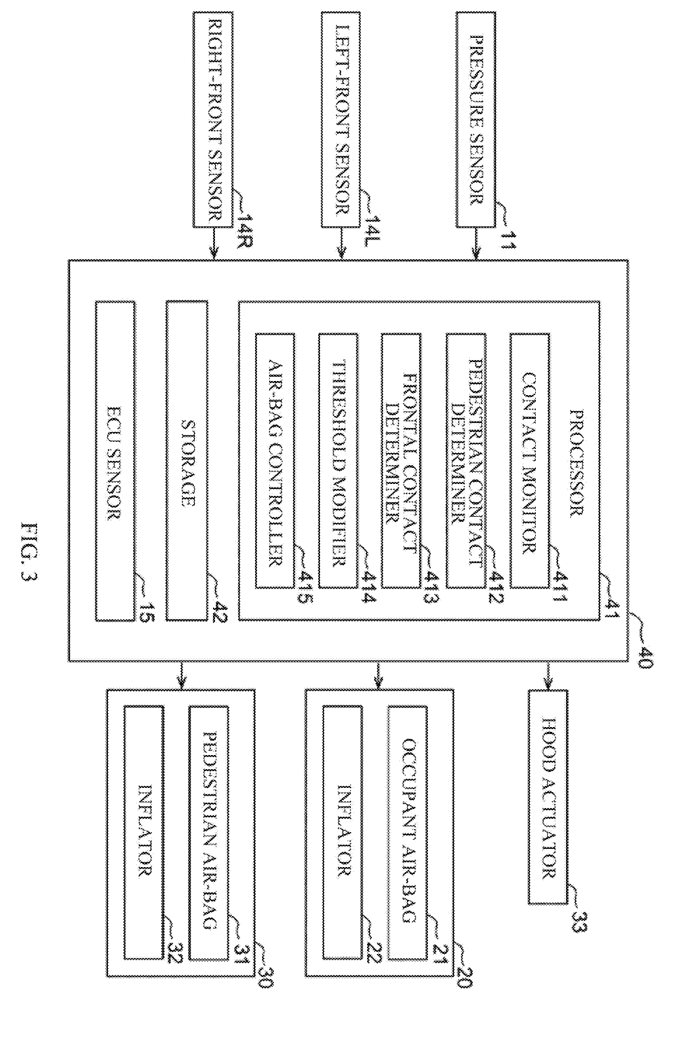

As illustrated in FIG. 2, a front hood 9 may be disposed above the frontal housing space 3. The front hood 9 may be configured to open and close about a non-illustrated hood hinge serving as a fulcrum. During normal use of the vehicle 1, the frontal housing space 3 may be closed by the front hood 9. As will be described in detail later, the hood hinge may be provided with a hood actuator 33 configured to pop up a rear portion of the front hood 9 upon actuation of a pedestrian protection device 30.

With reference to FIG. 1 again, a pressure sensor 11 may be provided between the bumper beam 5 and the bumper face 6. The pressure sensor 11 may include pressure detectors 13L and 13R in communication with a pressure tube 12 inside the front bumper 4. The pressure tube 12 may have, for example, an elongated shape along the front bumper 4. The pressure sensor 11 may detect a change in pressure when the pressure tube 12 is pressed upon a contact. The pressure sensor 11 may transmit a detection value to a control apparatus 40, which will be described later. In one embodiment, the pressure sensor 11 may serve as a "first sensor" disposed on on the frontal body of the vehicle 1 and usable in determining whether to actuate the pedestrian protection device 30, which will be described later.

A left-front sensor 14L may be disposed at a left-front position relative to the left-front side frame 8L. The left-front sensor 14L may be disposed on a left side of a non-illustrated radiator side frame, for example. The left-front sensor 14L may detect acceleration acting thereon in a longitudinal direction of the vehicle 1. In some embodiments, the left-front sensor 14L may detect acceleration acting thereon in the vehicle-width direction. The left-front sensor 14L may transmit a detection value to the control apparatus 40. In one embodiment, the left-front sensor 14L may serve as a "second sensor" disposed on the frontal body of the vehicle 1 and usable in determining whether to actuate an occupant protection device 20, which will be described later. As will be described in detail later, the use of the left-front sensor 14L enables earlier actuation of the occupant protection device 20 upon a center-pole contact or an underride contact.

A right-front sensor 14R may be disposed at a right-front position relative to the right-front side frame 8R. The right-front sensor 14R may be disposed on a right side of a non-illustrated radiator side frame, for example. The right-front sensor 14R may detect acceleration acting thereon in the longitudinal direction of the vehicle 1. In some embodiments, the right-front sensor 14R may detect acceleration acting thereon in the vehicle-width direction. The right-front sensor 14R may transmit a detection value to the control apparatus 40. In one embodiment, the right-front sensor 14R may serve as the "second sensor" disposed on the frontal body of the vehicle 1 and usable in determining whether to actuate the occupant protection device 20. As will be described in detail later, the use of the right-front sensor 14R enables earlier actuation of the occupant protection device 20 upon an center-pole contact or an underride contact.

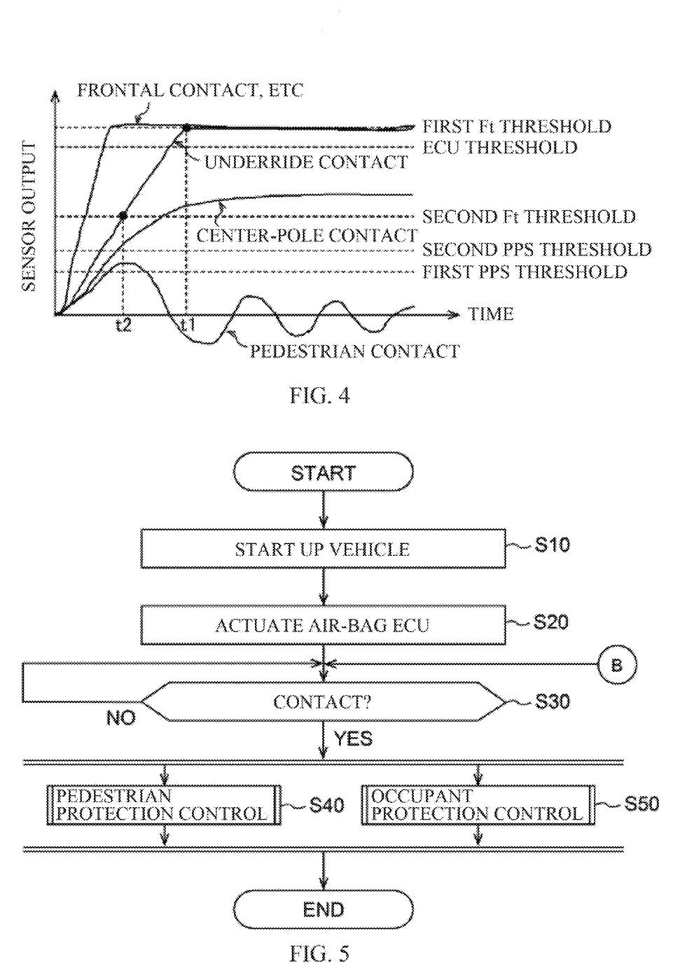

As illustrated in FIG. 3, the vehicle 1 may further include the occupant protection device 20, the pedestrian protection device 30, and the control apparatus 40.

The occupant protection device 20 may protect an occupant upon a contact of the vehicle 1. The occupant protection device 20 may include, for example, an occupant air-bag 21 and an inflator 22 configured to inject gas into the occupant air-bag 21.

The occupant air-bag 21 may be any known air-bag configured to protect the occupant upon a contact of the vehicle 1. The occupant air-bag 21 may include, for example, a driver's air-bag 21a, a passenger's air-bag 21b, and curtain air-bags 21c. The driver's air-bag 21amay be provided at a central portion of a non-illustrated steering wheel. Upon a contact of the vehicle 1, the driver's air-bag 21amay be inflated and deployed by the gas injected by the inflator 22. The passenger's air-bag 21b may be provided on a dash board in front of a passenger seat, for example. Upon a contact of the vehicle 1, the passenger's air-bag 21b may be inflated and deployed by the gas injected by the inflator 22. The curtain air-bags 21c may be provided on roof side rails of the vehicle 1. Upon a contact of the vehicle 1, the curtain air-bags 21c may be inflated and deployed by the gas injected by the inflator 22. During normal use of the vehicle 1, the occupant air-bag 21 may be folded and accommodated in an interior member of the vehicle 1, as appropriate.

The pedestrian protection device 30 may protect a pedestrian upon a contact of the vehicle 1. The pedestrian protection device 30 may include, for example, a pedestrian's air-bag 31 and an inflator 32 configured to inject gas into the pedestrian's air-bag 31. The pedestrian protection device 30 may be provided inside the front hood 9, for example. In this case, upon a contact of the vehicle 1, the hood actuator 33 provided on the hood hinge may pop up the rear portion of the front hood 9, and the pedestrian's air-bag 31 may be inflated and deployed in the vehicle-width direction by the gas injected by the inflator 32.

The control apparatus 40 may be attached to an upper surface of a central portion of a floor panel inside a vehicle compartment 10 of the vehicle 1, for example. As will be described in detail later, the control apparatus 40 controls the occupant protection device 20 and the pedestrian protection device 30 mounted in the vehicle 1, and includes one or more electronic air-bag control units (air-bag ECUs).

In the control apparatus 40, an ECU sensor 15 may be incorporated. The ECU sensor 15 may be configured to detect acceleration acting on the vehicle compartment 10 of the vehicle 1 in the longitudinal direction of the vehicle 1. In one embodiment, the ECU sensor 15 may serve as a "third sensor" incorporated in the control apparatus 40.

The vehicle 1 may further include any known devices to be used in driving control, such as a steering device, a braking device, or a vehicle control apparatus that are not illustrated. In some embodiments, the vehicle 1 may further include a non-illustrated B-pillar sensor and a non-illustrated C-pillar sensor that are configured to detect a side contact, in addition to the pressure sensor 11, the left-front sensor 14L, the right-front sensor 14R, and the ECU sensor 15. In some embodiments, the vehicle 1 may further include a non-illustrated front door sensor configured to detect a pole contact, which is one of the side contacts. In some embodiments, the vehicle 1 may further include a non-illustrated occupant detection sensor configured to detect a load of the occupant.

### 2. Control Apparatus

Now, the control apparatus 40 according to the present example embodiment will be described in detail with reference to FIG. 3.

### 2-1. Configuration Example

The control apparatus 40 serves as an apparatus that controls the occupant protection device 20 and the pedestrian protection device 30 mounted in the vehicle 1, by causing one or more central processing units (CPUs) to execute a computer program. The computer program may cause the processors to execute an operation to be performed by the control apparatus 40. In some embodiments, the computer program to be executed by the processors may be recorded in a recording medium serving as a storage (memory) 42, which will be described later. In some embodiments, the computer program may be recorded in a recording medium incorporated in the control apparatus 40 or any recording medium externally attachable to the control apparatus 40.

Non-limiting examples of the recording medium in which the computer program is to be recorded may include: a magnetic medium such as a hard disc, floppy disc, or magnetic tape; an optical recording medium such as a CD-ROM, DVD, or Blu-ray (registered trademark); a magnetooptical medium such as a floptical disc; a memory such as a random access memory (RAM) or read only memory (ROM); a flash memory such as a universal serial bus (USB) memory or solid state drive (SSD); and another medium configured to hold a program.

The control apparatus 40 includes a processor 41 and a storage 42 at least.

The processor 41 may include one or more processors such as CPUs, and various peripheral components. In some embodiments, a part or the entirety of the processor 41 may be configured by updatable software such as firmware, or a program module to be executed in accordance with a command from the processors such as CPUs.

The storage 42 may include one or more memories such as RAMs or ROMs communicably coupled to the processor 41. However, the storage 42 is not particularly limited in kind and number. The storage 42 may be configured to hold data such as the computer program to be executed by the processor 41, various parameters to be used in calculation processing, detection data, or calculation results.

In the storage 42, a threshold which is set for each of the left-front sensor 14L and the right-front sensor 14R corresponding to the second sensor usable in determining whether to actuate the occupant protection device 20 may be recorded in advance in such a manner that the processor 41 is allowed to refer to. Further, in the storage 42, a threshold of the pressure sensor 11 corresponding to the first sensor usable in determining whether to actuate the pedestrian protection device 30 may be recorded in advance in such a manner that the processor 41 is allowed to refer to. Further, in the storage 42, a threshold of the ECU sensor 15 corresponding to the third sensor incorporated in the control apparatus 40 may be recorded in advance in such a manner that the processor 41 is allowed to refer to.

The control apparatus 40 may be electrically coupled to each of the left-front sensor 14L and the right-front sensor 14R each corresponding to the second sensor, and the pressure sensor 11 corresponding to the first sensor. Further, the control apparatus 40 may be electrically coupled to each of the occupant protection device 20, which includes the occupant air-bag 21 and the inflator 22, the pedestrian protection device 30, which includes the pedestrian's air-bag 31 and the inflator 32, and the hood actuator 33.

### 2-2. Operational Configuration of Processor

Now, a description will be given of an exemplary configuration of the processor 41 of the control apparatus 40. The processor 41 may include a contact monitor 411, a pedestrian contact determiner 412, a frontal contact determiner 413, a threshold modifier 414, and an air-bag controller 415. These components may be functionalities to be implemented by executing the computer program by the one or more processors such as CPUs. In some embodiments, a part or the entirety of these components may be configured by analog circuitry.

### Contact Monitor

The contact monitor 411 may be configured to monitor whether the vehicle 1 is in contact with any contact body, based on detection values acquired by the first to third sensors. In some embodiments, the contact monitor 411 may determine that the vehicle 1 is in contact with any contact body upon receiving a detection signal received from any of the pressure sensor 11 corresponding to the first sensor, the left-front sensor 14L and the right-front sensor 14R each corresponding to the second sensor, and the ECU sensor 15 corresponding to the third sensor.

### Pedestrian Contact Detector

The pedestrian contact determiner 412 may determine that the pedestrian protection device 30 is to be actuated when the detection value of the first sensor exceeds the threshold usable in determining whether to actuate the pedestrian protection device 30. Further, the pedestrian contact determiner 412 may transmit a result of the determination indicating that the pedestrian protection device 30 is to be actuated to the air-bag controller 415. In some embodiments, the pedestrian contact determiner 412 may transmit the result of the determination indicating that the pedestrian protection device 30 is to be actuated to the air-bag controller 415 when a pressure P of the pressure sensor 11 corresponding to the first sensor exceeds a first PPS threshold. With reference to FIG. 4, the first PPS threshold may be usable in determining whether a detected contact of the vehicle 1 with a pedestrian involves protection of the pedestrian.

When the detection value of the first sensor exceeds the threshold usable in determining whether the contact of the vehicle 1 is likely to affect the occupant, the pedestrian contact determiner 412 may transmit a result of the determination to the frontal contact determiner 413. In some embodiments, when the pressure P of the pressure sensor 11 corresponding to the first sensor exceeds a second PPS threshold, the pedestrian contact determiner 412 may transmit the result of the determination to the frontal contact determiner 413. With reference to FIG. 4, the second PPS threshold may be greater than the first PPS threshold, and may be usable in determining whether a detected contact of the vehicle with, for example, an object other than a pedestrian is likely to affect the occupant of the vehicle 1. In some embodiments, the contact likely to affect the occupant of the vehicle 1 may be a center-pole contact or an underride contact that deforms a middle portion or an upper portion of the front bumper 4 of the vehicle 1.

Herein, the term "center-pole contact" may refer to a contact of a middle portion of the front body of the vehicle 1 with an object such as a utility pole. The center-pole contact may be a contact causing deceleration G less than that caused by a contact of the frontal vehicle of the vehicle 1 with a rigid body such as a wall or another vehicle. The term "underride contact" may refer to a contact of the front body of the vehicle 1 with a contact body such as a truck in which the vehicle 1 drives under a rear portion of the contact body. The underride contact may be a contact of the vehicle 1 causing deceleration less than that caused by a contact of the front body of the vehicle 1 with a rigid body such as a wall or another vehicle.

### Frontal Contact Determiner

The frontal contact determiner 413 may determine that the occupant protection device 20 is to be actuated when the detection value of the second sensor exceeds a preset threshold usable in determining whether to actuate the occupant protection device 20. Further, the frontal contact determiner 413 may transmit a result of the determination indicating that the occupant protection device 20 is to be actuated to the air-bag controller 415. In some embodiments, the frontal contact determiner 413 may transmit the result of the determination indicating that the occupant protection device 20 is to be actuated to the air-bag controller 415 when either an acceleration rate Gft of the left-front sensor 14L corresponding to the second sensor or an acceleration rate Gft of the right-front sensor 14R corresponding to the second sensor exceeds a first Ft threshold set in advance. With reference to FIG. 4, the first Ft threshold may be usable in determining whether a detected contact corresponds to a contact of the front body of the vehicle 1 with a rigid body, such as a wall or another vehicle, that causes relatively large deceleration.

The frontal contact determiner 413 may determine that the occupant protection device 20 is to be actuated when the detection value of the second sensor exceeds the threshold that is usable in determining whether to actuate the occupant protection device 20 and that is modified by the later-described threshold modifier 414. Further, the frontal contact determiner 413 may transmit the result of the determination indicating that the occupant protection device 20 is to be actuated to the air-bag controller 415. In some embodiments, when either an acceleration rate Gft of the left-front sensor 14L corresponding to the second sensor or an acceleration rate Gft of the right-front sensor 14R corresponding to the second sensor exceeds a second Ft threshold, the frontal contact determiner 413 may transmit the result of the determination indicating that the occupant protection device 20 is to be actuated to the air-bag controller 415. As will be described in detail later, the threshold modifier 414 may decrease the first Ft threshold to the second Ft threshold, thereby achieving an earlier determination of a center-pole contact or an underride contact.

In a case where the detection value of the second sensor does not exceed the preset threshold usable in determining whether to actuate the occupant protection device 20 and where the detection value of the first sensor exceeds the threshold usable in determining whether a detected contact is likely to affect the occupant of the vehicle 1, the frontal contact determiner 413 may determine whether the detection value of the third sensor is less than or equal to the threshold usable in determining whether to actuate the occupant protection device 20. When the detection value of the third sensor is less than or equal to the threshold usable in determining whether to actuate the occupant protection device 20, the frontal contact determiner 413 may transmit a result of the determination to the threshold modifier 414. In contrast, when the detection value of the third sensor is not less than or equal to the threshold usable in determining whether to actuate the occupant protection device 20, the frontal contact determiner 413 may determine that the occupant protection device 20 is to be actuated. In addition, the frontal contact determiner 413 may transmit a result of the determination indicating that the occupant protection device 20 is to be actuated to the air-bag controller 415.

In some embodiments, when an acceleration rate Gecu of the ECU sensor 15 corresponding to the third sensor is less than or equal to an ECU threshold, the frontal contact determiner 413 may transmit a result of the determination to the threshold modifier 414. In contrast, when the acceleration rate Gecu of the ECU sensor 15 corresponding to the third sensor is not less than or equal to the ECU threshold, the frontal contact determiner 413 may transmit a result of the determination indicating that the occupant protection device 20 is to be actuated to the air-bag controller 415. With reference to FIG. 4, the ECU threshold may be usable in distinguishing between a contact with a rigid body, such as wall or another vehicle, likely to cause large deceleration, and a contact, such as a center-pole contact or an underride contact, unlikely to cause large deceleration.

In other words, the frontal contact determiner 413 may determine that the occupant protection device 20 is to be actuated when the detection value of the second sensor exceeds the threshold before the modification. Further, the frontal contact determiner 413 may determine that the occupant protection device 20 is to be actuated when the detection value of the second detector exceeds the threshold after the modification, even if the detection value of the second sensor does not exceed the threshold before the modification and the frontal contact determiner 413 determines that the occupant protection device 20 is not to be actuated, based on the detection value of the third sensor incorporated in the control apparatus 40. In some embodiments, the determination based on the detection value of the third sensor may be omitted. In that case, the frontal contact determiner 413 may determine that the occupant protection device 20 is to be actuated when the detection value of the second sensor exceeds the threshold after the modification, even if the detection value of the second sensor does not exceed the threshold before the modification.

### Threshold Modifier

Upon receiving the result of the determination from the frontal contact determiner 413, the threshold modifier 414 may modify the threshold preset for the second sensor and usable in determining whether to actuate the occupant protection device 20. In some embodiments, upon receiving the result of the determination from the frontal contact determiner 413, the threshold modifier 414 may modify the threshold usable in determining whether to actuate the occupant protection device 20 by decreasing the first Ft threshold preset for the left-front sensor 14L and the right-front sensor 14R each corresponding to the second sensor to the second Ft threshold.

With reference to FIG. 4, the second Ft threshold may be usable in determining whether a detected contact corresponds to a contact, such as a center-pole contact or an underride contact, unlikely to cause large deceleration. In some embodiments, the second Ft threshold may be appropriately set in consideration of a rise timing and a magnitude of the acceleration rate Gft (i.e., sensor output) of each of the left-front sensor 14L and the right-front sensor 14R corresponding to the second sensor. The underride contact tends to cause the sensor output to rise at a later timing and to have a larger magnitude than the sensor output of the center-pole contact. In contrast, the center-pole contact tends to cause the sensor output to rise at an earlier timing and to have a smaller magnitude than the sensor output of the underride contact. Accordingly, the second Ft threshold may be set as a threshold usable in distinguishing between these tendencies.

That is, the threshold modifier 414 modifies the threshold of the second sensor disposed on the front body of the vehicle 1 and usable in determining whether to actuate the occupant protection device 20, based on the detection value of the first sensor disposed on the front body of the vehicle 1 and usable in determining whether to actuate the pedestrian protection device 30. In some embodiments, the threshold modifier 414 may decrease the threshold of the second sensor when the pedestrian contact determiner 412 determines that the contact is likely to affect the occupant of the vehicle 1, based on the detection value of the first sensor.

This enables an earlier determination of the center-pole contact or underride contact. The term "earlier" may mean that time t2 until the curve of a detection value of the underride contact illustrated in, for example, FIG. 4 reaches the second Ft threshold is within a range of about 30% of time t1 until the curve reaches the first Ft threshold. However, the meaning of the term "earlier" is not limited thereto.

### Air-bag Controller

Upon receiving the result of the determination indicating that the pedestrian protection device 30 is to be actuated from the pedestrian contact determiner 412, the air-bag controller 415 may execute control of actuating the pedestrian protection device 30. In some embodiments, the air-bag controller 415 may output a driving signal to the hood actuator 33 and output an actuation signal to the inflator 32 included in the pedestrian protection device 30. As a result, the rear portion of the front hood 9 may be opened by the hood actuator 33, and the pedestrian's air-bag 31 may be inflated by the inflator 32 and deployed from the rear portion of the front hood 9 in the vehicle-width direction. The pedestrian's air-bag 31 protects the pedestrian.

Upon receiving the result of the determination indicating that the occupant protection device 20 is to be actuated from the frontal contact determiner 413, the air-bag controller 415 may perform control of actuating the occupant protection device 20. In some embodiments, the air-bag controller 415 may output an actuation signal to the inflator 22 included in the occupant protection device 20. As a result, the occupant air-bag 21 may be inflated by the inflator 22 and deployed within the vehicle compartment 10 of the vehicle 1. The occupant air-bag 21 protects the occupant.

### 2-3. Exemplary Operation of Control Apparatus

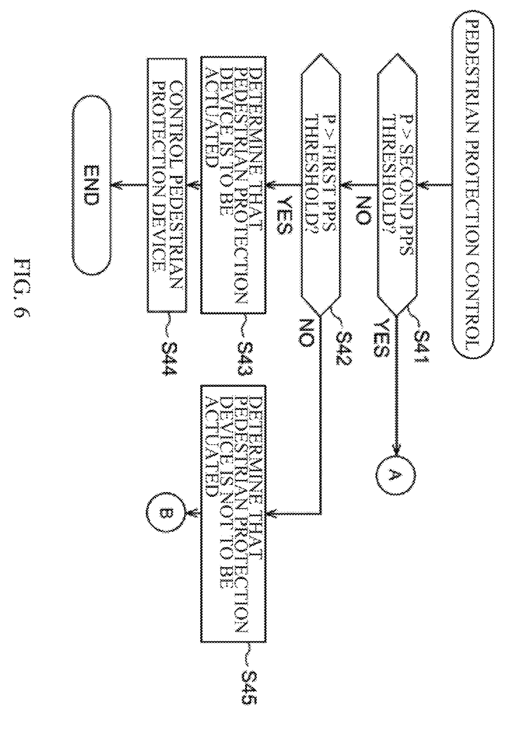

Now, an exemplary operation of the control apparatus 40 according to the present example embodiment will be described with reference to a flowchart illustrated in FIG. 5.

In Step S10, the vehicle 1 may be started up when a non-illustrated ignition switch or a non-illustrated start switch provided in the vicinity of a driver's seat of the vehicle 1 is pressed by a driver who drives the vehicle 1. Thereafter, the procedure may proceed to Step S20.

In Step S20, the air-bag ECU corresponding to the control apparatus 40 may be actuated in response to a power supply from a non-illustrated low-voltage battery mounted in the vehicle 1. This may cause the contact monitor 411 of the processor 41 of the control apparatus 40 to start monitoring occurrence of contact. Thereafter, the procedure may proceed to Step S30.

In Step S30, the contact monitor 411 of the processor 41 may determine whether the vehicle 1 is in contact with any contact body. In some embodiments, the contact monitor 411 of the processor 41 may determine that the vehicle 1 is in contact with any contact body upon receiving any detection signal from one or more sensors of the pressure sensor 11 corresponding to the first sensor, the left-front sensor 14L corresponding to the second sensor, the right-front sensor 14R corresponding to the second sensor, and the ECU sensor 15 corresponding to the third sensor.

If it is determined that the vehicle 1 is in contact with any contact body (Step S30: YES), the procedure may proceed to Steps S40 and S50. In some embodiments, Steps S40 and S50 may be executed in parallel. If it is not determined that the vehicle 1 is in contact with any contact body (Step S30: NO), the procedure may wait until a contact is detected in Step S30. In other words, the contact monitor 411 of the processor 41 may continuously monitor whether a contact is detected.

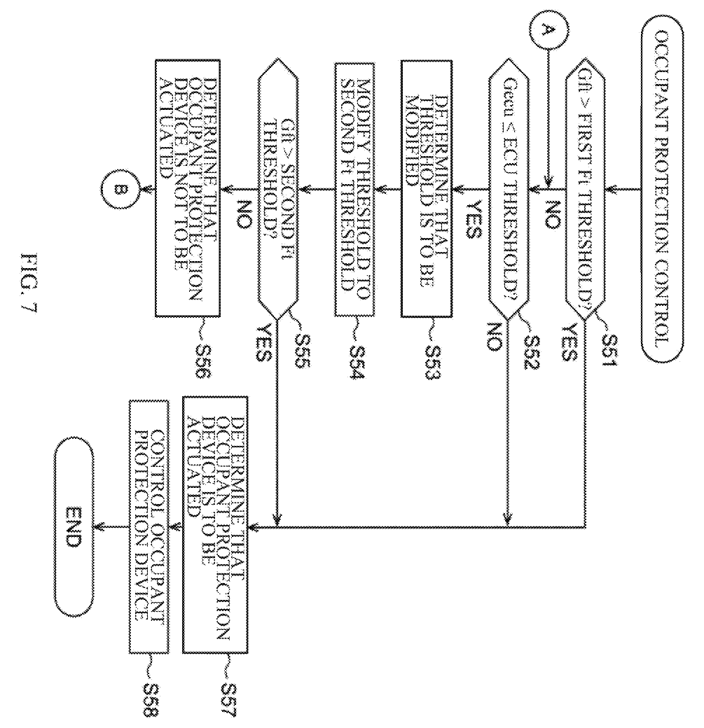

If the procedure proceeds from Step S30 to Step S40, the processor 41 of the control apparatus 40 may execute pedestrian protection control in Step S40. In the following, the pedestrian protection control will be described in detail with reference to FIG. 6.

In Step S41, the pedestrian contact determiner 412 of the processor 41 may determine whether the pressure P corresponding to the detection value of the pressure sensor 11 corresponding to the first sensor is greater than the second PPS threshold. The determination may be made within a predetermined time after it is determined as "YES" in Step S30. The predetermined time may be set in advance in, for example, a simulation or an experiment. If it is determined that the pressure P is greater than the second PPS threshold (Step S41: YES), the procedure may proceed to Step S51, which will be described later with reference to FIG. 7. In other words, it may be determined in Step S51 that the contact detected in Step S30 of FIG. 5 corresponds to a center-pole contact or an underride contact that is likely to deform the middle portion or the upper portion of the front bumper 4 of the vehicle 1 and affect the occupant of the vehicle 1. If it is not determined that the pressure P is greater than the second PPS threshold (Step S41: NO), the procedure may proceed to Step S42.

In Step S42, the pedestrian contact determiner 412 of the processor 41 may determine whether the pressure P corresponding to the detection value of the pressure sensor 11 corresponding to the first sensor is greater than the first PPS threshold. The determination may be made within a predetermined time after it is determined as "NO" in Step S41. The predetermined time may be set in advance in, for example, a simulation or an experiment. If it is determined that the pressure P is greater than the first PPS threshold (Step S42: YES), the procedure may proceed to Step S43. In other words, it may be determined in Step 43 that the contact detected in Step S30 of FIG. 5 corresponds to a contact that involves protection of a pedestrian. If it is not determined that the pressure P is greater than the first PPS threshold (Step S42: NO), the procedure may proceed to Step S45.

If the procedure proceeds from Step S42 to Step S43, the pedestrian contact determiner 412 of the processor 41 may determine in Step S43 that the pedestrian protection device 30 is to be actuated , and transmit a result of the determination to the air-bag controller 415. Thereafter, the procedure may proceed to Step S44.

Upon receiving the result of the determination transmitted in Step S43, the air-bag controller 415 of the processor 41 may execute the control of actuating the pedestrian protection device 30 in Step S44. Accordingly, the pedestrian's air-bag 31 may be inflated and deployed in such manner as described above. Thereafter, the procedure may end.

If the procedure proceeds from Step S42 to Step S45, the pedestrian contact determiner 412 of the processor 41 may determine in Step S45 that the pedestrian protection device 30 is not to be actuated. Thereafter, the procedure may wait until a contact is detected in Step S30 of FIG. 5. In other words, the contact monitor 411 of the processor 41 may continuously monitor whether a contact is detected.

With reference to FIG. 5 again, if the procedure proceeds from Step S30 to Step S50, the processor 41 of the control apparatus 40 may execute occupant protection control in Step S50. In the following, the occupant protection control will be described in detail with reference to FIG. 7.

In Step S51, the frontal contact determiner 413 of the processor 41 may determine whether either the acceleration rate Gft corresponding to the detection value of the left-front sensor 14L corresponding to the second sensor or the acceleration rate Gft corresponding to the detection value of the right-front sensor 14R corresponding to the second sensor is greater than the first Ft threshold. The determination may be made within a predetermined time after it is determined as "YES" in Step S41. The predetermined time may be set in advance in, for example, a simulation or an experiment. In some embodiments, the predetermined time may be shorter than the time t2 illustrated in FIG. 4. If it is determined that either of the acceleration rates Gft is greater than the first Ft threshold (Step S51: YES), the procedure may proceed to Step S57. In other words, it may be determined in Step S51 that the contact detected in Step S30 of FIG. 5 corresponds to a contact of the front body of the vehicle 1 with a rigid body, such as a wall or another vehicle, that causes relatively large deceleration. If it is determined that neither of the acceleration rates Gft is greater than the first Ft threshold (Step S51: NO), the procedure may proceed to Step S52. In other words, it may be determined in Step S51 that the contact detected in Step S30 of FIG. 5 corresponds to a contact, such as a center-pole contact or an underride contact, unlikely to cause large deceleration.

In Step S52, the frontal contact determiner 413 of the processor 41 may determine whether the acceleration rate Gecu corresponding to the detection value of the ECU sensor 15 corresponding to the third sensor is less than or equal to the ECU threshold. The determination may be made within a predetermined time after it is determined as "NO" in Step S51. The predetermined time may be set in advance in, for example, a simulation or an experiment. In some embodiments, the predetermined time may be shorter than the time t2 illustrated in FIG. 4. If it is determined that the acceleration rate Gecu is less than or equal to the ECU threshold (Step S52: YES), the procedure may proceed to Step S53. If it is not determined that the acceleration rate Gecu is less than or equal to the ECU threshold (Step S52: NO), the procedure may proceed to Step S57. In other words, it may be determined in Step S52 that the contact detected in Step S30 of FIG. 5 corresponds to a contact of the front body of the vehicle 1 with a rigid body, such as a wall or another vehicle, that causes relatively large deceleration.

As described with reference to FIG. 6, Step S52 may be executed when it is determined in Steo S41 that the pressure P corresponding to the detection value of the pressure sensor 11 corresponding to the first sensor is greater than the second PPS threshold. Accordingly, when it is determined as "YES" in Step S52 (Step S52: YES), it may be determined that the contact detected in Step S30 of FIG. 5 corresponds to a contact, such as a center-pole contact or an underride contact, unlikely to cause large deceleration.

In Step S53, the frontal contact determiner 413 of the processor 41 may determine that the Ft threshold usable in determining whether to actuate the occupant protection device 20, which is set for each of the left-front sensor 14L and the right-front sensor 14R corresponding to the second sensor, is to be modified, and transmit a result of the determination to the threshold modifier 414. Thereafter, the procedure may proceed to Step S54.

Upon receiving the result of the determination transmitted in Step S53 in Step S54, the threshold modifier 414 of the processor 41 may modify the Ft threshold usable in determining whether to actuate the occupant protection device 20 by decreasing the first Ft threshold to the second Ft threshold. This enables an earlier determination of the contact detected in Step S30 of FIG. 5 to be a center-pole contact or an underride contact. Thereafter, the procedure may proceed to Step S55.

In Step S55, the frontal contact determiner 413 of the processor 41 may determine whether either the acceleration rate Gft corresponding to the detection value of the left-front sensor 14L corresponding to the second sensor or the acceleration rate Gft corresponding to the detection value of the right-front sensor 14R corresponding to the second sensor is greater than the second Ft threshold. The determination may be made within a predetermined time after the threshold is modified in Step S54. The predetermined time may be set in advance in, for example, a simulation or an experiment. If it is determined that either of the acceleration rates Gft is greater than the second Ft threshold (Step S55: YES), the procedure may proceed to Step S57. In other words, it may be determined in Step S55 that the contact detected in Step S30 of FIG. 5 corresponds to a center-pole contact or an underride contact that involves protection of the occupant. If it is determined that neither of the acceleration rates Gft is greater than the second Ft threshold (Step S55: NO), the procedure may proceed to Step S56.

Using both the second PPS threshold and the second Ft threshold smaller than the first Ft threshold in determining whether to actuate the occupant protection device 20 enables an earlier determination of a center-pole contact or an underride contact and prevents unnecessary actuation of the occupant protection device 20 when a detected contact corresponds to a contact that does not involve deployment of the occupant protection device 20.

In Step S56, the frontal contact determiner 413 of the processor 41 may determine that the occupant protection device 20 is not to be actuated. Thereafter, the procedure may wait until a contact is detected in Step S30 of FIG. 5. In other words, the contact monitor 411 of the processor 41 may continuously monitor whether a contact is detected.

If the procedure proceeds from Step S51, Step S52, or Step S55 to Step S57, the frontal contact determiner 413 of the processor 41 may determine in Step S57 that the occupant protection device 20 is to be actuated, and transmit a result of the determination to the air-bag controller 415. Thereafter, the procedure may proceed to Step S58.

Upon receiving the result of the determination transmitted in Step S57, the air-bag controller 415 of the processor 41 may execute the control of actuating the occupant protection device 20 in Step S58. Accordingly, the occupant air-bag 21 may be inflated and deployed in such a manner as described above when it is determined that the contact detected in Step S30 of FIG. 5 corresponds to a contact of the front body of the vehicle 1 with a rigid body, such as a wall or another vehicle, that causes large deceleration. Further, the occupant air-bag 21 may be inflated and deployed at an earlier timing as described above, even if it is determined that the contact detected in Step S30 of FIG. 5 corresponds to a contact, such as a center-pole contact or an underride contact, unlike to case large deceleration. This improves detection performance for a center-pole contact or an underride contact. Thereafter, the procedure may end.

### 3. Conclusion

As described above, the processor 41 of the control apparatus 40 according to the present example embodiment is configured to modify the Ft threshold, which is set for each of the left-front sensor 14L and the right-front sensor 14R corresponding to the second sensor disposed on the front body of the vehicle 1 and usable in determining whether to actuate the occupant protection device 20, based on the detection value of the first sensor disposed on the front body of the vehicle 1 and usable in determining whether to actuate the pedestrian protection device 30.

In some embodiments, the processor 41 of the control apparatus 40 may execute the following control when it is determined, based on the detection value of the pressure sensor 11 corresponding to the first sensor, that the detected contact is likely to affect the occupant of the vehicle 1. When the detection values of the left-front sensor 14L and the right-front sensor 14R each corresponding to the second sensor do not exceed the Ft threshold before the modification (i.e., the first Ft threshold) and the processor 41 determines that the occupant protection device 20 is not to be actuated, based on the detection value of the ECU sensor 15 corresponding to the third sensor incorporated in the control apparatus 40, the processor 41 may modify the Ft threshold by decreasing the Ft threshold to the second Ft threshold. Thereafter, the processor 41 may determine the occupant protection device 20 is to be actuated when the detection values of the left-front sensor 14L and the right-front sensor 14R each corresponding to the second sensor exceed the Ft threshold after the modification (i.e., the second Ft threshold).

According to the configuration described above, by decreasing the Ft threshold, it is possible to shorten the time until it is determined that a detected contact corresponds to a center-pole contact or an underride contact that causes deceleration of the vehicle 1 at a later timing than a contact with a rigid body, such as a wall or another vehicle. It is therefore possible to achieve earlier actuation of the occupant protection device 20 upon the center-pole contact or the underride contact.

Although some example embodiments of the disclosure have been described in detail in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof. For example, the constituent elements or functions included in each step may be rearranged without causing any logical inconsistency, and a plurality of constituent elements or steps may be combined into a single element or step, or alternatively divided.

### 4. Modification Example

According to one modification example, when the occupant protection device 20 is determined to be actuated, the processor 41 of the control apparatus 40 may further execute one or both of fire prevention control and high-voltage shielding control on the vehicle 1. The fire prevention control may be control that stops supplying fuel to an internal combustion engine corresponding to the driving power source 2, and may be executed by a non-illustrated engine ECU that controls the internal combustion engine in accordance with a command from the processor 41 of the control apparatus 40. The high-voltage shielding control may be control that shields a non-illustrated high-voltage battery configured to supply electric power to a drive motor corresponding to the driving power source 2 from a non-illustrated high-voltage battery circuit, and may be executed by a non-illustrated battery ECU configured to control the high-voltage battery in accordance with a command from the processor 41 of the control apparatus 40.

For example, in Step S57 of FIG. 7, the processor 41 of the control apparatus 40 may further determine that the one or both of the fire prevention control and the high-voltage shielding control are to be executed. Thereafter, in Step S58, the processor 41 of the control apparatus 40 may further execute one or both of the fire prevention control and the high-voltage shielding control. In Step S56, the processor 41 of the control apparatus 40 may further determine that neither the fire prevention control nor the high-voltage shielding control is to be executed. It is to be noted that the high-voltage shielding control may be executed in a case where the vehicle 1 is an electric vehicle.

### 5. Others

The technology of the disclosure may be implemented as the vehicle 1 including the control apparatus 40 according to any of the foregoing example embodiments, a control method to be executed by the control apparatus 40 according to any of the foregoing example embodiments, a computer program that causes a computer to serve as the control apparatus 40 according to any of the foregoing example embodiments, or a non-transitory tangible recording medium in which the computer program is recorded.

The limitations in the claims are to be interpreted broadly based on the language employed in the claims and not limited to examples described in this specification or during the prosecution of the application, and the examples are to be construed as non-exclusive. As used in this specification and the appended claims, the singular forms "a," "an," and "the" include, especially in the context of the claims, are to be construed to cover both the singular and the plural, unless otherwise indicated herein or clearly contradicted by context. Throughout this specification and the appended claims, unless the context requires otherwise, the terms "comprise", "include", "have", and their variations are to be construed to cover the inclusion of a stated element, integer, or step but not the exclusion of any other non-stated element, integer, or step. The use of the terms first, second, etc. do not denote any order or importance, but rather the terms first, second, etc. are used to distinguish one element from another. The term "substantially", "approximately", "about", and its variants having the similar meaning thereto are defined as being largely but not necessarily wholly what is specified as understood by one of ordinary skill in the art. The term "disposed on/ provided on/ formed on" and its variants having the similar meaning thereto as used herein refer to elements disposed directly in contact with each other or indirectly by having intervening structures therebetween.

The control apparatus 40 illustrated in FIG. 3 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control apparatus 40 illustrated in FIG. 3. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control apparatus 40 illustrated in FIG. 3.

1. A control apparatus configured to control an occupant protection device and a pedestrian protection device that are configured to be mounted in a vehicle, the control apparatus comprising:
one or more processors configured to modify a threshold of a second sensor, based on a detection value of a first sensor, the first sensor being disposed on a front body of the vehicle and usable in determining whether to actuate the pedestrian protection device, the second sensor being disposed on the front body of the vehicle and usable in determining whether to actuate the occupant protection device; and
one or more memories communicably coupled to the one or more processors.

2. The control apparatus according to claim 1, wherein
the occupant protection device is configured to be actuated when a detection value of the second sensor exceeds the threshold, and
the one or more processors are configured to, upon determining, based on the detection value of the first sensor, that a detected contact corresponds to a contact likely to affect an occupant of the vehicle, make a modification to the threshold by decreasing the threshold.

3. The control apparatus according to claim 2, wherein the one or more processors are configured to determine that the occupant protection device is to be actuated, when the detection value of the second sensor exceeds the threshold after the modification, even in a case where the detection value of the second sensor does not exceed the threshold before the modification.

4. The control apparatus according to claim 2, further comprising a third sensor, wherein the one or more processors are configured to determine that the occupant protection device is to be actuated, when the detection value of the second sensor exceeds the threshold after the modification, even in a case where the detection value of the second sensor does not exceed the threshold before the modification and where the one or more processors determine, based on a detection value of the third sensor, that the occupant protection device is not to be actuated.

5. The control apparatus according to claim 3, wherein the one or more processors are further configured to, upon determining that the occupant protection device is to be actuated, execute one or both of fire prevention control and high-voltage shielding control on the vehicle.

6. The control apparatus according to claim 4, wherein the one or more processors are further configured to, upon determining that the occupant protection device is to be actuated, execute one or both of fire prevention control and high-voltage shielding control on the vehicle.
